(19) United States
(12) Patent Application Publication
(10) Pub. No.: US 2007/0180079 A1
(43) Pub. Date: Aug. 2, 2007

(54) Method and system for peer-to-peer stream

(75) Inventors: Chi-Ching Wei, Taipei (TW); Mao-Hung Cheng, Taipei (TW); Shih-Chen Lo, Taipei (TW)

Correspondence Address: BAKER & MCKENZIE LLP;PATENT DEPARTMENT, 2001 ROSS AVENUE, SUITE 2300, DALLAS, TX, 75201, US

(73) Assignee: Santrum Networks Inc.

(21) Appl. No.: 11/342,763

(22) Filed: Jan. 30, 2006

(51) Int. Cl. G06F 15/173

(52) U.S. Cl. 709/223

(57) ABSTRACT

A peer-to-peer system and a method of file streaming therein are disclosed. The peer-to-peer system includes a first electronic device connected to second and third electronic devices via a first network connection. The second and the third electronic devices are connected to each other via a second network connection, wherein a file is transmitted from one of the second and the third electronic devices to the other one of the second and the third electronic devices through the second network connection.

### FIELD OF THE INVENTION

This invention relates generally to the field of peer-to-peer streaming and, more particularly, certain embodiments of the present invention relate to the field of peer-to-peer streaming where a secure connection may be established between clients so that files being transferred need not pass through a server when streamed.

### BACKGROUND OF THE INVENTION

With the rapid development of Internet technologies, resource sharing over networks has become more and more popular. A peer-to-peer (P2P) structure is one way to facilitate such resource sharing. However, when it comes to downloading multimedia files with copyrights protection under a peer-to-peer structure, many countries prohibit or restrict such behavior.

Another problem faced with transferring files with large sizes from one end-point to another end-point is that it takes a lot of time for users to upload and download the files to and from a P2P server.

Additionally, in the commercial product BitTorrent, files to be shared must first be published on the Internet before allowing others to download them. As a result, sensitive and private data may become exposed to the outside world.

Although popular software applications, such as MSN and Skype, also provide a file transfer functionality, they don't allow a user to search and retrieve files from remote computers. Furthermore, the file transfer provided by MSN and Skype is very slow. For example, a 400-MBytes-file transfer between two MSN users may take 24 hours to transmit in such systems.

Therefore, there is a need for a peer-to-peer system for receiving files and a method thereof that overcomes the above-identified problems. Additionally, a system that can further remotely execute an application and invite clients to share resources and a method thereof are desired.

### SUMMARY OF THE INVENTION

In order to achieve the above-identified objects, a system and method for peer-to-peer file streaming are provided according to certain embodiments of the present invention.

In one aspect of the present invention, the system includes a first electronic device connected to second and third electronic devices via a first network connection. The second and third electronic devices are connected to each other via a second network connection, wherein a file is transmitted from one of the second and third electronic devices to the other one of the second and third electronic devices through the second network connection.

In another aspect of the present invention, the method used in a peer-to-peer system includes registering first and second clients in a first server; assigning a virtual IP address to the second client; establishing a second network connection between the first and second clients; and streaming a file from one of the first and the second clients to the other one of the first and second clients via the second network connection.

### BRIEF DESCRIPTION OF THE DRAWINGS

FIG. 1 is a schematic diagram showing a peer-to-peer system in accordance with one embodiment of the present invention; and

FIG. 2 is a flow chart of peer-to-peer file streaming in accordance with one embodiment of the present invention.

### DETAILED DESCRIPTION OF THE INVENTION

Reference will now be made in detail to embodiments of the present invention. Examples of embodiments are illustrated in the accompanying drawings, wherein like reference numbers refer to like elements throughout the specification.

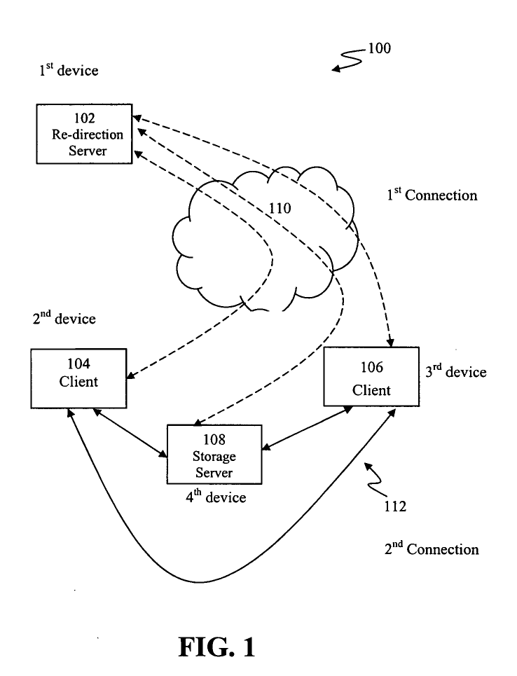

FIG. 1 illustrates one embodiment of a peer-to-peer system in accordance with the present invention. In the first embodiment, the peer-to-peer system 100 includes a first electronic device 102, a second electronic device 104, and a third electronic device 106. The first electronic device 102 is a re-direction server, while the second electronic device 104 and the third electronic device 106 are clients. Additionally, the second and the third electronic devices 104, 106 can be a desktop, a notebook or a hand-held device, such as a cellular phone, that has a network connection interface.

As shown in FIG. 1, the first electronic device 102, the second electronic device 104 and the third electronic device 106 are connected to a first network connection 110, namely the Internet. However, the first electronic device 102, the second electronic device 104 and the third electronic device 106 can also be connected via other public connection means that are known by those skilled in the art.

In the first embodiment of the present invention, the first electronic device 102, namely the re-direction server, allows the second electronic device 104 and the third electronic device 106, namely the clients, to register their information. The first electronic device 102, namely the re-direction server, can further maintain the registration data stored therein such that a good record of which electronic devices are registered in the peer-to-peer system 100 can be kept.

After registration, the first electronic device 102, namely the re-direction server, assigns a virtual IP address to each of the second electronic device 104 and the third electronic device 106, namely the clients. By assigning virtual IP addresses of the same subnet mask, the second electronic device 104 and the third electronic device 106, which originally come from different networks and are connected via the first network connection 110, namely the Internet, can now treat each other as if they are in the same network.

Furthermore, a second network connection 112 is established between the second electronic device 104 and the third electronic device 106, as shown in FIG. 1. In the first embodiment of the present invention, the second network connection 112 is a secured network connection, such as a VPN tunnel or an HTTPS connection. As a result, a file, such as an audio file, a video file or a picture file, can be transmitted between the second electronic device 104 and the third electronic device 106 through the second network connection 112 without passing through the first electronic device 102 and then being directed to the third electronic device 106.

In other words, for example, when the second electronic device 104, namely one client, streams an MP3 file to the third electronic device 106, namely another client, the file is streamed directly to third electronic device 106 through the second network connection 112 as if the second and the third electronic devices 104, 106 are in the same network (e.g., a local area network), instead of having to cache the file first in the first electronic device 102, namely the re-direction server, and then stream the file from the first electronic device 102 to the third electronic device 106, namely the client.

Additionally, a file list, such as a multimedia list showing all the songs available, can be exchanged between the second electronic device 104 and the third electronic device 106, such that files stored in one of the electronic devices, such as the second electronic device 104, can be known by the other one of the electronic devices, such as the third electronic device 106. For instance, before the second electronic device 104, namely one client, streams an MP3 file to the third electronic device 106, namely another client, the third electronic device 106 may want to know what files are stored in the second electronic device 104. As a result, the third electronic device 106 can send a request to the second electronic device 104, asking the second electronic device 104 to show a multimedia list indicating all the songs available at the second electronic device 104.

After receiving such request, the second electronic device 104 can directly send the file list to the third electronic device 106 via the second network connection 112, namely the secured connection. The second electronic device 104 can also ask the third electronic device 106 to send a multimedia list in return. Again, because the second network connection 112, namely the secured connection, is already established between the second electronic device 104 and the third electronic device 106, the file list can be exchanged directly between the two electronic devices through the second network connection 112 without having first to pass the multimedia list to the first electronic device 102 and then pass the list to the third electronic device 106.

Furthermore, one of the second electronic device 104 and the third electronic device 106 can remotely execute an application installed on the other one of the second electronic device 104 and the third electronic device 106 in accordance with certain embodiments of the present invention. For example, if its the birthday of the user of the second electronic device 104, the user of the third electronic device 106 may want to wish the user of the second electronic device 104 a happy birthday by sending him a birthday song. To do so, the user of the third electronic device 106 can remotely execute a multimedia application, such as Windows Media Player, installed on the second electronic device 104 to play the birthday song.

In one embodiment, a message will be prompted on the screen (not shown) of the second electronic device 104, indicating that the user of the third electronic device 106 would like to activate the Media Player installed thereon to play a birthday song. If the user of the second electronic device 104 accepts such activation, the Windows Media Player installed on the second electronic device 104 will be activated to play the song chosen by the user of the third electronic device 106. If the user of the second electronic device 104 declines such activation, the Windows Media Player installed on the second electronic device 104 will not be activated to play the song chosen by the user of the third electronic device 106. The user of the third electronic device 106 can further be notified that the user of the second electronic device 104 has declined such activation.

The second electronic device 104 and the third electronic device 106 can further invite each other to share audio, video, and picture files directly through the second network connection 112 in accordance with certain embodiments of the present invention. Because the second electronic device 104 and the third electronic device 106 are assigned with virtual IP addresses in the same subnet, and because the second network connection 112 is established between the second and the third electronic devices 104, 106, the users of the second and the third electronic devices 104, 106, can share files the same way as if they were in the same network (e.g., for instance a local area network).

As shown in FIG. 1, the peer-to-peer system 100 can further include a fourth electronic device 108. The fourth electronic device 108 is also connected to the first electronic device 102, namely the re-direction server, through the first network connection 110, namely the Internet.

In the first embodiment of the present invention, the fourth electronic device 108 is a storage server storing a plurality of files, including audio, video and picture files. The fourth electronic device 108, namely the storage server, can also register its information in the first electronic device 102, the re-direction server, through the first network connection 110. In return, the first electronic device 102, namely the re-direction server, assigns the fourth electronic device 108, namely the storage server, with a virtual IP address in the same subnet as those assigned to the second, and the third electronic devices 104, 106, namely the clients.

After registration, the second network connection 112 is established among the second electronic device 104, the third electronic device 106 as well as the fourth electronic device 108, such that the second, the third and the fourth electronic devices 104, 106 and 108 can treat each other as if they are in the same local area network. In other words, the two clients and the storage server that are located in the different networks can now treat each other as if they are in the same network via the secured connection. As a result, the second and the third electronic devices 104 and 106, namely the clients, can directly exchange files stored in the fourth electronic device 108, namely the storage server.

For example, the second electronic device 104, namely the client, can retrieve a file stored in the fourth electronic device 108, namely the storage server, through the second network connection 112, namely the secured connection, and then stream the file directly to the third electronic device 106, namely the client, through the second network connection 112. In another example, the third electronic device 106, namely the client, can directly share a file stored in the fourth electronic device 108, namely the storage server, with the second electronic device 104, namely the client, such that the second electronic device 104 can directly access the file through the second network connection 112.

In either case, the files are shared, streamed, and accessed through the second network connection 112, namely the secured connection. In other words, no files need to be published in the first network connection 110, or be passed through the first electronic device 102, namely the re-direction server, and then be passed to the third electronic device 106, namely the designated client.

In the second embodiment of the present invention, the peer-to-peer system 100 includes the first electronic device 102, the second electronic device 104 and the third electronic device 106. Similar to the first embodiment, in the second embodiment of the present invention, the first electronic device 102 is a re-direction server, while the second electronic device 104 and the third electronic device 106 are clients. Additionally, the second and third electronic devices 104, 106 can be a desktop, a notebook or a hand-held device, such as a cellular phone, that has a network connection interface.

As shown in FIG. 1, the first electronic device 102 is connected to the second electronic device 104 and the third electronic device 106 via the first network connection 110, namely the Internet. However, the first electronic device 102 can also connect to the second electronic device 104 and the third electronic device 106 via other public connection means known by those skilled in the art.

In the second embodiment of the present invention, the second and the third electronic devices 104, 106, namely the clients, register their information in the first electronic device 102, namely the re-direction server, through the first network connection 110. The first electronic device 102, namely the re-direction server, maintains the registered information of the second and the third electronic devices 104, 106, namely the clients, such that a good record of which electronic devices are registered in the peer-to-peer system 100 can be kept.

However, in the second embodiment, it is the second electronic device 104, namely the client, that assigns a virtual IP address to the third electronic device 106, namely the other client, instead of the first electronic device 102, namely the re-direction server, after the registration is complete. By assigning virtual IP addresses of the same subnet mask, the second electronic device 104 and the third electronic device 106, which come from different networks via the Internet, can now treat each other as if they are in the same network. The second network connection 112 is established between the second and the third electronic devices 104 and 106, such that a file can be transmitted between the second and the third electronic devices 104 and 106 without having to be passed to the first electronic device 102 first and then be passed to the third electronic device 106.

In other words, for example, when the second electronic device 104 streams an audio file to the third electronic device 106, the file is streamed directly to the third electronic device 106 through the second network connection 112 instead of having to pass the file first to the first electronic device 102 and then from the first electronic device 102 to the third electronic device 106.

Additionally, a file list in one of the second electronic device 104 and the third electronic device 106 can be exchanged between the second electronic device 104 and the third electronic device 106, such that the files stored in one of the electronic devices, such as the second electronic device 104, can be known by the other one of the electronic devices, such as the third electronic device 106. For instance, before the second electronic device 104 streams the audio file to the third electronic device 106, the third electronic device 106 may want to know which files are stored in the second electronic device 104. As a result, the third electronic device 106 can send a request to the second electronic device 104, asking the second electronic device 104 to show a multimedia list.

After receiving such request, the second electronic device 104 can directly send the file list to the third electronic device 106 via the second network connection 112. The second electronic device 104 can also ask the third electronic device 106 to send a multimedia list in return. Again, because the second network connection 112, namely the secured connection, is already established between the second electronic device 104 and the third electronic device 106, the file list can be exchanged directly between the two electronic devices through the second network connection 112 without having to pass the multimedia list to the first electronic device 102 first and then pass the list to the third electronic device 106.

Furthermore, one of the second electronic device 104 and the third electronic device 106 can remotely execute an application installed on the other one of the second electronic device 104 and the third electronic device 106 in accordance with certain embodiments of the present invention. For example, if its the birthday of the user of the second electronic device 104, the user of the third electronic device 106 may want to wish the user of the second electronic device 104 a happy birthday by sending him a birthday song. To do so, the user of the third electronic device 106 can remotely execute a multimedia application, such as Windows Media Player, installed on the second electronic device 104 to play the birthday song.

In one embodiment, a message will be prompted on the screen (not shown) of the second electronic device 104, indicating that the user of the third electronic device 106 would like to activate the Media Player installed thereon to play a birthday song. If the user of the second electronic device 104 accepts such activation, the Windows Media Player installed on the second electronic device 104 will be activated to play the song chosen by the user of the third electronic device 106. If the user of the second electronic device 104 declines such activation, the Windows Media Player installed on the second electronic device 104 will not be activated to play the song chosen by the user of the third electronic device 106. The user of the third electronic device 106 can further be notified that the user of the second electronic device 104 has declined such activation.

The second electronic device 104 and the third electronic device 106 can further invite each other to share audio, video, and picture files directly through the second network connection 112 in accordance with certain embodiments of the present invention. Because the second electronic device 104 and the third electronic device 106 are assigned virtual IP addresses in the same subnet, and because the second network connection 112 is established between the second and the third electronic devices 104, 106, the users of the second and the third electronic devices, 104 and 106, can share files the same way as if they were in the same network, (e.g., a local area network).

As shown in FIG. 1, the peer-to-peer system 100 can further include the fourth electronic device 108. The fourth electronic device 108 is also connected to the first electronic device 102 through the first network connection 110, namely the Internet.

In the second embodiment, the fourth electronic device 108 is a storage server storing a plurality of files, including audio, video and picture files. The fourth electronic device 108, namely the storage server, can also register in the first electronic device 102, namely the re-direction server. After registration, the second electronic device 104 assigns a virtual IP address to the fourth electronic device 108, such that the fourth electronic device 108 is in the same subnet as the second and the third electronic devices 104, 106.

In the second embodiment of the present invention, the second network connection 112 is established among the second electronic device 104, the third electronic device 106 as well as the fourth electronic device 108, such that the second, the third and the fourth electronic devices 104, 106 and 108 can treat each other as if they are in the same network. As a result, the second and the third electronic devices 104 and 106 can directly exchange files stored in the fourth electronic device 108.

For example, the second electronic device 104, namely one client, can retrieve a file stored in the fourth electronic device 108, namely the storage server, through the second network connection 112, namely the secure connection, and then stream the file directly to the third electronic device 106, namely the other client, through the second network connection 112. In another example, the third electronic device 106 can directly share a file stored in the fourth electronic device 108, namely the storage server, with the second electronic device 104 such that the second electronic device 104 can directly access the file through the second network connection 112.

In either case, the files are shared, streamed, and accessed through the second network connection 112, namely the secured connection. In other words, no files need to be published in the first network connection 110, or be passed through the first electronic device 102, namely the re-direction server, and then be passed to the third electronic device 106, namely the designated client.

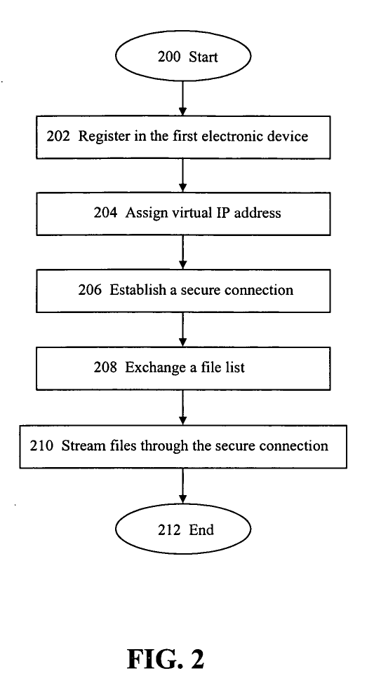

FIG. 2 illustrates a flow chart of the file streaming method in accordance with certain embodiments of the present invention. The method that is used in the peer-to-peer system 100 starts at step 200. As mentioned above, the peer-to-peer system 100 includes the first electronic device 102, the second electronic device 104 and the third electronic device 106. In the preferred embodiment, the first electronic device 102 is a re-direction server, while the second electronic device 104 and the third electronic device 106 are clients. Additionally, the second and third electronic devices 104, 106 can be a desktop, a notebook or a hand-held device, such as a cellular phone, that has a network connection interface.

The first electronic device 102 is connected to the second electronic device 104 and the third electronic device 106 via the first network connection 110, namely the Internet. However, the first electronic device 102 can also connect to the second electronic device 104 and the third electronic device 106 via other public connection means known by those skilled in the art.

As shown in FIG. 2, at step 202, the second and the third electronic devices 104 and 106, namely the clients, register their information in the first electronic device 102, namely the re-direction server, through the first network connection 110. Optionally, the first electronic device 102, namely the re-direction server, maintains the registered information of the second and the third electronic devices 104 and 106, namely the clients, such that a good record of which electronic devices are registered in the peer-to-peer system 100 can be kept.

Next, depending on whether it is the first electronic device 102, namely the re-direction server, or the second electronic device 104, namely the client, that assigns virtual IP addresses, as the first and second embodiments described above, either the first electronic device 102, namely the re-direction server, assigns a virtual IP address to each of the second and the third electronic devices 104 and 106, namely the clients, or the second electronic device 104, namely one client, assigns a virtual IP address to the third electronic device 106, namely the other client, at step 204. By assigning virtual IP addresses of the same subnet mask, the second electronic device 104 and the third electronic device 106, which come from different networks via the Internet, can now treat each other as if they are in the same network.

At step 206, the second network connection 112, namely the secured connection, is established between the second and the third electronic devices 104, 106. Optionally, in the scenario where the fourth electronic device 108, namely the second server or the storage server, is present, the second network connection 112 is established among the second, the third and the fourth electronic devices 104, 106 and 108.

After the secured connection is established, at step 208, a file list can be exchanged between the second electronic device 104 and the third electronic device 106, such that the files stored in one of the electronic devices, such as the second electronic device 104, or the fourth electronic device 108, namely the storage server, can be known by the other one of the electronic devices, such as the third electronic device 106.

Next, a file is streamed from one of the second and the third electronic devices 104, 106, such as the second electronic device 104, to the other one of the second and the third electronic devices 104 and 106, such as the second electronic device 104, at step 210. In other words, a file can be streamed between the second and the third electronic devices 104 and 106 as if it is streamed between two clients in the same network such as a local area network, instead of having first to be passed to the first electronic device 102, namely the server, and then be passed to the third electronic device 106. Additionally, the file can be first retrieved from the fourth electronic device 108 and then streamed from one of the second and the third electronic devices 104, 106 to the other one of the second and the third electronic devices 104, 106.

In another embodiment of the present invention, at step 210, instead of streaming files between the second electronic device 104 and the third electronic device 106, one of the second and the third electronic devices 104, 106 can also remotely execute an application installed on the other one of the second and the third electronic devices 104, 106 via the second network connection 112. As in the birthday scenario described above, after the second network connection 112, namely the secured connection, is established between the second and the third electronic devices 104, 106, the user of the third electronic device 106 can remotely execute a multimedia application, such as Windows Media Player, installed on the second electronic device 104 to play a birthday song.

In one embodiment, the step 204 of remotely executing an application can further include prompting a message on the screen (not shown) of the second electronic device 104, indicating that the user of the third electronic device 106 would like to activate the Media Player installed thereon to play the birthday song. If the user of the second electronic device 104 accepts such activation, the Windows Media Player installed on the second electronic device 104 will be activated to play the song chosen by the user of the third electronic device 106. If the user of the second electronic device 104 declines such activation, the Windows Media Player installed on the second electronic device 104 will not be activated to play the song chosen by the user of the third electronic device 106. The user of the third electronic device 106 can further be notified that the user of the second electronic device 104 has declined such activation.

In another embodiment of the present invention, at step 210, instead of streaming files between the second electronic device 104 and the third electronic device 106, the second electronic device 104 and the third electronic device 106 can further invite each other to share audio, video, and picture files directly through the second network connection 112 in accordance with the present invention. Because the second electronic device 104 and the third electronic device 106 are assigned with virtual IP addresses in the same subnet and because that the second network connection 112 is established between the second and the third electronic devices 104, 106, the users of the second and the third electronic devices 104 and 106, can share files the same way as if they were in a local area network. The method ends at step 212.

Although the invention has been described in considerable detail with reference to the preferred embodiments thereof, other versions are within the scope of the present invention. Therefore, the spirit and scope of the appended claims should not be limited to the description of the preferred embodiments contained herein.

What is claimed is:

1. A peer-to-peer system, comprising:
a first electronic device;
a second electronic device;
a third electronic device;
wherein said first electronic device is connected to said second and third electronic devices via a first network connection, and
said second and said third electronic devices are connected to each other via a second network connection,
wherein at least one file may be transmitted from one of said second and said third electronic devices to the other one of said second and said third electronic devices through said second network connection.

2. The system of claim 1, wherein said first electronic device assigns virtual IP addresses to said second and third electronic devices via said first network connection.

3. The system of claim 1, wherein said second electronic device assigns a virtual IP address to said third electronic device via said first network connection.

4. The system of claim 1, wherein said second and said third electronic devices are registered in said first electronic device.

5. The system of claim 4, wherein said first electronic device maintains registered information of said second and third electronic devices.

6. The system of claim 1, wherein one of said second and third electronic devices directly exchanges a file list with the other one of said second and third electronic devices via said second network connection.

7. The system of claim 1, wherein one of said second and third electronic devices remotely executes an application installed on the other one of said second and third electronic devices via said second network connection.

8. The system of claim 1, wherein one of said second and third electronic devices directly shares a file with the other one of said second and third electronic devices via said second network connection.

9. The system of claim 1, wherein said first electronic device is a server.

10. The system of claim 1, wherein said second electronic device is a hand-held electronic device.

11. The system of claim 1, wherein said second network connection is a secured network connection.

12. The system of claim 1, further comprising: a fourth electronic device, said fourth electronic device connected to said first electronic device via said first network connection, and said fourth electronic device connected to said second and third electronic devices via said second network connection.

13. The system of claim 12, wherein said fourth electronic device is a storage server for storing a plurality of files for said second and third electronic devices to access via said second network connection.

14. A file receiving method used in a peer-to-peer system, said system comprising a first server, a first client and a second client, said first server connected to said first and second clients via a first network connection, said method comprising:
registering at least one of said first and second clients in said first server;
assigning a virtual IP address to said second client;
establishing a second network connection between said first and second clients; and
transmitting a file from one of said first and second clients to the other of said first and second clients via said second network connection.

15. The method of claim 14, further comprising: assigning a virtual IP address to said first client.

16. The method of claim 14, further comprising: remotely executing one application installed in one of said first and second clients from the other of said first and second clients via said second network connection.

17. The method of claim 14, further comprising: maintaining registered information in said first server.

18. The method of claim 14, further comprising: establishing said second network connection among said first client said second client, and a second server, said second server being a storage server storing a plurality of files.

19. The method of claim 14, further comprising: exchanging a list between said first and said second clients via said second network connection.

20. The method of claim 14, further comprising: sharing a file between said first and said second clients via said second network connection.

21. A peer-to-peer file transferring method, comprising:
registering in a first server via a first network connection;
discovering an electronic device connected to a second network connection, said second network connection being different from said first network connection;
requesting a file via said second connection; and
receiving said file through said second network connection.

22. The method of claim 21, further comprising: exchanging a file list with said electronic device via said second network connection.

23. The method of claim 21, further comprising: remotely executing an application installed on said electronic device via said second network connection.

24. The method of claim 21, further comprising: sharing a file with said electronic device via said second network connection.

25. A peer-to-peer file transferring method, comprising:
registering in a first server via a first network connection;
discovering an electronic device connected to a second network connection, said second network connection being different from said first network connection; and
sending a file via said second network connection.

26. The method of claim 25, further comprising: assigning a virtual IP address to said electronic device.

27. The method of claim 25, further comprising: sharing a file with said electronic device via said second network connection.

28. The method of claim 25, further comprising: remotely executing an application installed on said electronic device via said second network connection.

29. The method of claim 25, further comprising: exchanging a file list with said electronic device via said second network connection.

30. A peer-to-peer system, comprising:
a server connected to at least two clients via a first network connection; and
said at least two clients connected to each other via a second network connection,
wherein a file is transmitted from one of said at least two clients to the other one of said at least two clients through said second network connection.

31. The system of claim 30, wherein said server assigns virtual IP addresses to said at least two clients connected thereto via said first network connection so as to establish said second network connection.

32. The system of claim 30, wherein one of said at least two clients assigns virtual IP addresses to the other one of said at least two clients via said first network connection so as to establish said second network connection.

33. The system of claim 30, wherein said at least two clients are registered in said server.

34. The system of claim 30, wherein said server maintains registered information regarding said at least two clients.

35. The system of claim 30, wherein one of said at least two clients directly exchanges a file list with another one of said at least two clients.

36. The system of claim 30, wherein one of said at least two clients remotely executes an application installed on another one of said at least two clients via said second network connection.

37. The system of claim 30, wherein one of said at least two clients directly shares a file with another one of said at least two clients via said second network connection.

38. The system of claim 30, wherein one of said at least two clients is a hand-held electronic device.
